(19) United States
(12) Patent Application Publication
(10) Pub. No.: US 2024/0338575 A1
(43) Pub. Date: Oct. 10, 2024

(54) DIGITAL TWIN FEDERATION METHOD AND DIGITAL TWIN FOR PERFORMING THE SAME

(71) Applicant: ELECTRONICS AND TELECOMMUNICATIONS RESEARCH INSTITUTE, Daejeon (KR)

(72) Inventors: Changkyu LEE, Daejeon (KR); Hyun Jeong LEE, Daejeon (KR)

(73) Assignee: ELECTRONICS AND TELECOMMUNICATIONS RESEARCH INSTITUTE, Daejeon (KR)

(21) Appl. No.: 18/627,712

(22) Filed: Apr. 5, 2024

(30) Foreign Application Priority Data
Apr. 7, 2023 (KR) 10-2023-0045949
Mar. 20, 2024 (KR) 10-2024-0038645

(51) Int. Cl. G06N 3/098

(52) U.S. Cl. CPC G06N 3/098

(57) ABSTRACT

A method of forming a federated digital twin and a digital twin for performing the method are disclosed. The digital twin includes general functions (GF) configured to provide a function and data of the digital twin and federation orchestration functions (FOF), wherein the FOF are configured to discover one or more other digital twins to federate with the digital twin, determine, from among the discovered digital twins, a digital twin to form a federated digital twin, and form the federated digital twin by establishing a communication connection with the determined digital twin.

### CROSS-REFERENCE TO RELATED APPLICATION

This application claims the benefit of Korean Patent Application No. 10-2023-0045949 filed on Apr. 7, 2023, and Korean Patent Application No. 10-2024-0038645 filed on Mar. 20, 2024, in the Korean Intellectual Property Office, the entire disclosures of which are incorporated by reference herein for all purposes.

### BACKGROUND

### 1. Field of the Invention

One or more embodiments relate to a digital twin federation method and a digital twin for performing the same.

### 2. Description of the Related Art

A digital twin, as a digital representation of an observable object of interest, possesses data and functions to achieve the purpose of the digital twin.

Digital twin federation involves integrating different digital twins to share data and functions each digital twin possesses. Through a digital twin federation, services that a single digital twin may not provide may be offered.

### SUMMARY

According to various embodiments, a digital twin federation method and a digital twin for performing the same provide functions of components necessary for performing digital twin federation for interworking between digital twins and provide a process of digital twin federation utilizing each function.

According to an aspect, there is provided a digital twin including general functions (GF) configured to provide a function and data of the digital twin and federation orchestration functions (FOF), wherein the FOF may be configured to discover one or more other digital twins to federate with the digital twin, determine, from among the discovered digital twins, a digital twin to form a federated digital twin, and form the federated digital twin by establishing a communication connection with the determined digital twin.

The FOF may be configured to utilize the function and data of the digital twin by interacting with the GF or utilize data and a result received from another digital twin included in the federated digital twin.

The FOF may be configured to manage an identifier of a digital twin included in the federated digital twin and a federation status of the federated digital twin.

The FOF may be configured to determine a digital twin to form the federated digital twin, based on feature information of the one or more other digital twins received from a registry connected to the FOF for communication or predetermined feature information.

The FOF may be configured to establish a communication connection with the determined digital twin through a communication adaptor when a direct communication connection with the determined digital twin is unavailable.

The FOF may be configured to process a function and data requested by a digital twin included in the federated digital twin, obtain a result of the requested function and data by interacting with the GF, and transmit the result of the requested function and data to the digital twin included in the federated digital twin.

According to another aspect, there is provided a federated digital twin including a first digital twin, at least one second digital twin federated with the first digital twin among a plurality of digital twins other than the first digital twin, and a registry configured to establish a communication connection with the first digital twin and the plurality of digital twins and store feature information of the first digital twin and feature information of the plurality of digital twins, wherein each of the first digital twin and the at least one second digital twin may include GF configured to provide a function and data and FOF, and wherein the FOF of the first digital twin may be configured to discover feature information of the plurality of digital twins registered in the registry, determine, from among the at least one second digital twin, a digital twin to form the federated digital twin, at least based on the discovered feature information, and form the federated digital twin by establishing a communication connection with the determined digital twin.

The FOF of the first digital twin may be configured to utilize a function and data of the first digital twin by interacting with the GF of the first digital twin or utilize data and a result received from another digital twin included in the federated digital twin.

The FOF of the first digital twin may be configured to manage an identifier of a digital twin included in the federated digital twin and a federation status of the federated digital twin.

The FOF of the first digital twin may be configured to determine a digital twin to form the federated digital twin, based on feature information of the at least one second digital twin received from the registry or pre-stored feature information

The FOF of the first digital twin may be configured to establish a communication connection with the determined digital twin through a communication adaptor when a direct communication connection with the determined digital twin is unavailable.

According to another aspect, there is provided a digital twin federation method including discovering one or more other digital twins to federate with a digital twin using FOF included in the digital twin, determining, from among the discovered digital twins, a digital twin to form a federated digital twin using the FOF, and using the FOF, forming the federated digital twin by establishing a communication connection with the determined digital twin.

The digital twin may include GF configured to provide a function and data of the digital twin, and the digital twin federation method may further include utilizing the function and data of the digital twin by interacting with the GF or utilizing data and a result received from another digital twin included in the federated digital twin.

The digital twin federation method may further include managing an identifier of a digital twin included in the federated digital twin and a federation status of the federated digital twin using the FOF.

The determining of the digital twin to form the federated digital twin may include determining a digital twin to form the federated digital twin, based on feature information of the one or more other digital twins received from a registry connected to the FOF for communication or predetermined feature information.

The forming of the federated digital twin may include establishing a communication connection with the determined digital twin through a communication adaptor when a direct communication connection with the determined digital twin is unavailable.

The digital twin federation method may further include processing a function and data requested by a digital twin included in the federated digital twin, obtaining a result of the requested function and data by interacting with GF included in the digital twin, and transmitting the result of the requested function and data to a digital twin included in the federated digital twin.

Additional aspects of embodiments will be set forth in part in the description which follows and, in part, will be apparent from the description, or may be learned by practice of the disclosure.

According to various embodiments, different digital twins may share their functions and data with each other, and through a federated digital twin, services that a single digital twin is not able to provide may be offered.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a schematic block diagram illustrating a configuration of digital twin federation, according to various embodiments;

FIG. 2 is a schematic block diagram illustrating a reference architecture of digital twin federation, according to various embodiments;

FIG. 3 is a schematic block diagram of a digital twin, according to various embodiments;

FIG. 4 is a schematic block diagram of a registry, according to various embodiments;

FIG. 5 is a schematic block diagram of a communication adaptor, according to various embodiments;

FIG. 6 is a diagram illustrating an operation of a digital twin to register feature information in a registry, according to various embodiments;

FIG. 7 is a diagram illustrating an operation of a digital twin to discover feature information registered in a registry, according to various embodiments;

FIG. 8 is a diagram illustrating an operation of a digital twin to establish a communication connection with another digital twin, according to various embodiments;

FIGS. 9A, 9B, and 9C are diagrams illustrating an operation of a digital twin to establish a communication connection with another digital twin using a communication adaptor, according to various embodiments;

FIGS. 10A and 10B are diagrams illustrating an operation of a digital twin to perform data communication with another digital twin, according to various embodiments; and

FIGS. 11A and 11B are diagrams illustrating an operation of a digital twin to perform data communication with another digital twin using a communication adaptor, according to various embodiments.

### DETAILED DESCRIPTION

Hereinafter, embodiments will be described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

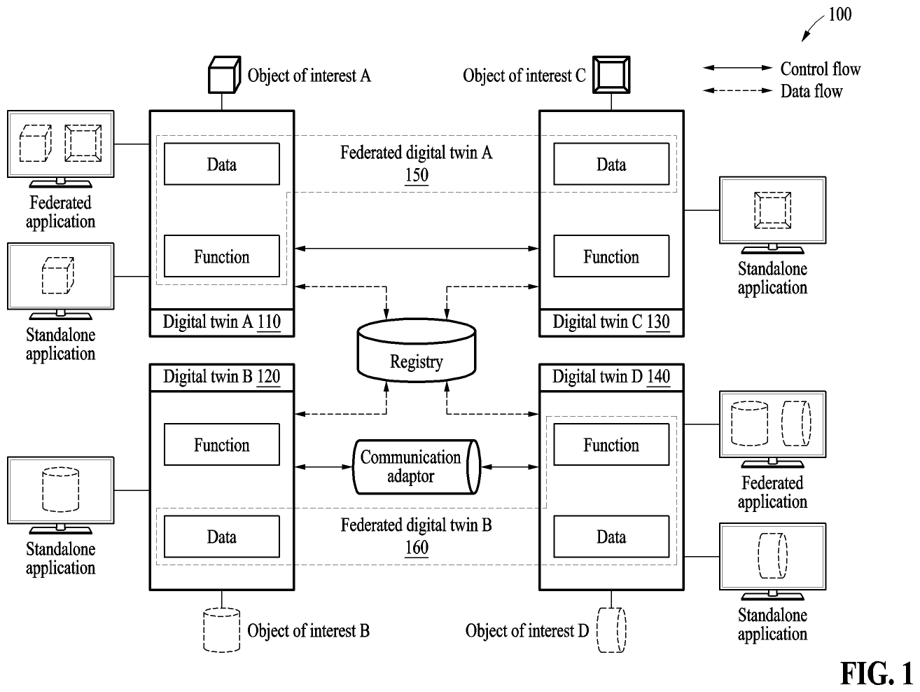

FIG. 1 is a schematic block diagram 100 illustrating a configuration of digital twin federation, according to various embodiments.

As illustrated in FIG. 1, digital twin A 110 may establish a direct communication connection with digital twin C 130, and the digital twin A 110 and the digital twin C 130 may form federated digital twin A 150.

As illustrated in FIG. 1, digital twin D 140 may establish an indirect communication connection with digital twin B 120, and digital twin D 140 may form federated digital twin B 160 with digital twin B 120. For example, the digital twin D 140 may establish an indirect communication connection with the digital twin B 120 via a communication adaptor.

A standalone application for each digital twin may provide a unique service provided by each of the digital twin A 110, the digital twin B 120, the digital twin C 130, and the digital twin D 140.

A federated application for the digital twin A 110 may provide a service through the federated digital twin A 150. A federated application for the digital twin D 140 may provide a service through federated digital twin B 160.

A registry and the communication adaptor may support digital twin discovery to form a federated digital twin, the establishment of a federated digital twin, communication with components of the formed federated digital twin, and the like.

For example, the registry may be a component that registers feature information of a digital twin and provides the registered feature information according to a discovery request from a digital twin. When digital twins for performing digital twin federation are determined in advance and feature information is shared among the digital twins, registration and discovery through the registry may not be needed.

For example, the communication adaptor may be a component that provides a direct connection between digital twins. An indirect connection supported by the communication adaptor may be used when a direct connection may not be established because of, for example, security between digital twins or when direct communication may not be established because of, for example, protocol or format mismatches.

A digital twin (e.g., the digital twin A 110, the digital twin B 120, the digital twin C 130, and the digital twin D 140) may be a component that directly performs digital twin federation. Each digital twin may receive a service through a standalone application or a federated application.

For example, the digital twin A 110 may be a digital twin for providing an emergency medical service, and the digital C 130 may be a transportation digital twin.

A federated digital twin may be an entity generated as a result of digital twin federation and may be an extended version of a digital twin that starts the digital twin federation. For example, the federated digital twin A 150 may be an extended version of the digital twin A 110 using data from the digital twin C 130.

An application may provide a service. The application may be divided into a standalone application and a federated application. The standalone application is provided by a digital twin without performing digital twin federation, while the federated application is provided through digital twin federation.

An object of interest may be an object that is represented in a digital form within a digital twin. According to an embodiment, the object of interest may not be included in the scope of digital twin federation. The object of interest (or a physical object) may include observable resources such as a human, equipment, a device, a material, a process, a facility, and an environment.

Digital twin federation may be an operation of exchanging various pieces of data for an application service among a plurality of digital twins based on a predetermined request to achieve a predetermined purpose, as illustrated in FIG. 1. As a result of performing digital twin federation, a logical digital twin may be generated. An application service may be provided across not only single domains but also complex domains through the generated logical digital twin. In FIG. 1, each of the federated digital twin A 150 and the federated digital twin B 160 may represent a logical digital twin generated as a result of performing digital twin federation.

As described above, digital twin federation may be performed through the interaction of a digital twin, a registry, and a communication adaptor. An application and an object of interest may be for the understanding of digital twins and digital twin federation. The timing of generating each digital twin may vary.

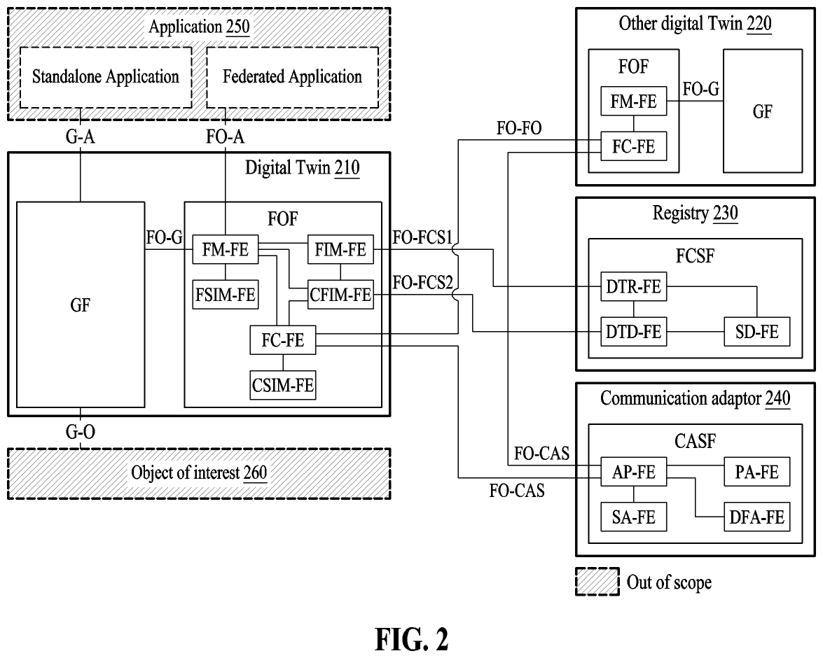

In FIGS. 2 to 11C, in order to describe the functions and operations of a digital twin, a registry, and a communication adaptor, the functions and functional entities of the digital twin, the registry, and/or the communication adaptor are described as performing each operation. However, this is for convenience of description, and embodiments are not limited thereto.

For example, the digital twin, the registry, and/or the communication adaptor may each include a processor and/or a memory including processing circuitry. In FIGS. 2 to 11C, the operations performed by the functions and functional entities of the digital twin, the registry, and/or the communication adaptor may be performed in substantially the same manner by each of the digital twin, the registry, and/or the communication adaptor using the processor and/or the memory.

In other words, the descriptions of the operations of the functions and/or the functional entities of the digital twin, the registry, and/or the communication adaptor are provided with reference to FIGS. 2 to 12 for ease of convenience. The digital twin, the registry, and/or the communication adaptor may each use a processor, processing circuitry, and a memory included in each of the digital twin, the registry, and/or the communication adaptor to perform operations that are substantially the same as the operations described with reference to FIGS. 2 to 11C.

FIG. 2 is a schematic block diagram illustrating a reference architecture of digital twin federation, according to various embodiments.

Referring to FIG. 2, a digital twin federation may include a digital twin 210, an other digital twin 220, a registry 230, a communication adaptor 240, an application 250, and/or an object of interest 260.

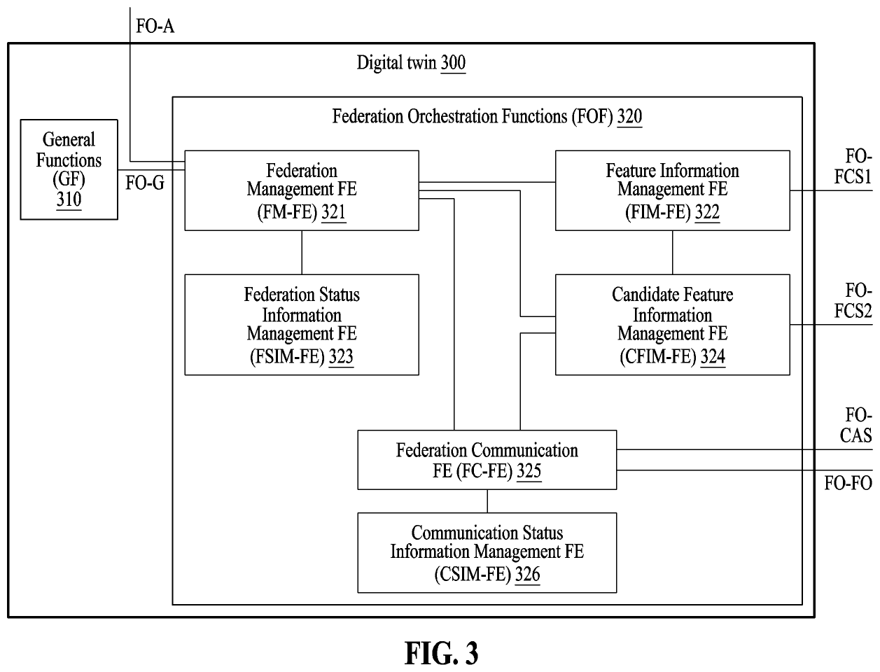

The digital twin 210 may include general functions (GF) and federation orchestration functions (FOF). The other digital twin 220 may include GF and FOF. The various functional entities (FEs) (e.g., a federation management (FM)-FE, a federation status information management (FSIM)-FE, a feature information management (FIM)-FE, a candidate feature information management (CFIM)-FE, a federation communication (FC)-FE, and a communication status information management (CSIM)-FE) included in the FOF and the various reference points (e.g., FO-A, FO-G, FO-FCS 1, and FO-FCS 2) connected to the FEs illustrated in FIG. 2 are described in detail with reference to FIG. 3.

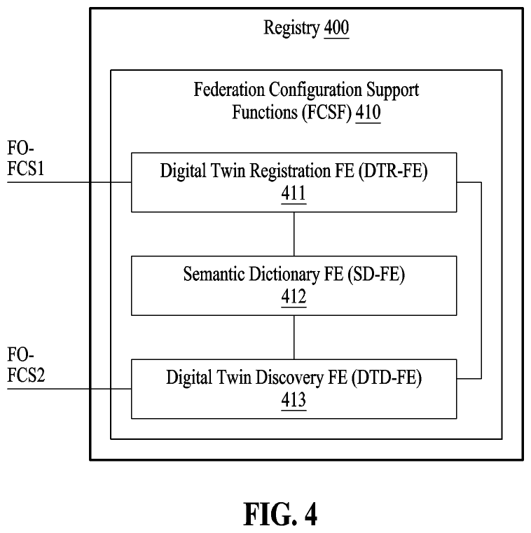

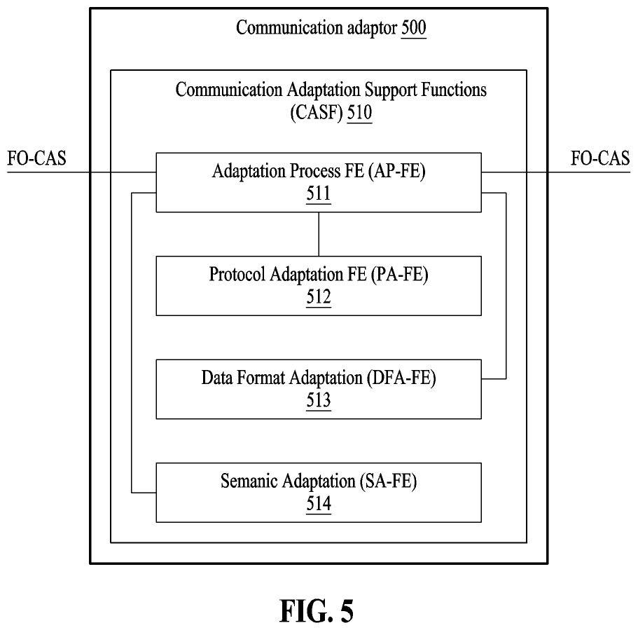

The registry 230 may include federation configuration support functions (FCSF). The communication adaptor 240 may include communication adaptation support functions (CASF). Various FEs (e.g., a digital twin registration (DTR)-FE, a digital twin discovery (DTD)-FE, and a semantic dictionary (SD)-FE) included in the FCSF and various reference points (e.g., FO-FCS 1 and FO-FCS 2) connected to the FEs included in the FCSF are described in detail with reference to FIG. 4. Various FEs (e.g., an adaptation process (AP)-FE, a protocol adaptation (PA)-FE, a semantic adaptation (SA)-FE, and a data format adaptation (DFA)-FE) included in the CASF and various reference points (e.g., FO-A and FO-CAS) connected to the FEs included in the CASF are described in detail with reference to FIG. 5.

The application 250 may include a standalone application and a federated application.

The registry 230 may register feature information of each digital twin and provide the registered feature information according to the request from a digital twin.

For example, when predefined members (e.g., digital twins of a digital twin federation) of a digital twin federation share functional information in various manners, the digital twin 210 and/or the other digital twin 220 may use stored information (e.g., feature information, functional information, etc.) to form the digital twin federation without registering feature information using the registry 230 and without searching for or discovering feature information registered in the registry 230.

When digital twins are unable to establish direct communication (e.g., when the digital twin 210 and the other digital twin 220 are unable to establish a direct communication connection), the communication adaptor 240 may establish indirect communication between the digital twins.

A digital twin may provide a standalone application and/or a federated application. For example, when the digital twin 210 federates with the other digital twin 220 to form a digital twin federation, the digital twin 210 may provide a function and/or a service of the digital twin 210 through the standalone application and provide a function and/or a service of the digital twin federation through the federated application.

The application 250 may include the standalone application provided by a digital twin (e.g., the digital twin 210 or the other digital twin 220) without digital twin federation and the federated application provided by a digital twin federation in which multiple digital twins federate with each other. Configurations of the standalone application and/or the federated application, functions and/or services provided by the standalone application and/or the federated application may be determined according to a function and/or a service provided by each digital twin and a function and/or a service provided by a digital twin federation.

The object of interest 260 (or physical entity) may represent a predetermined object observable by a digital twin and may have a unique function. The configuration, function, and the like of the object of interest 260 may be determined according to an object observed by each digital twin.

In FIG. 2, the GF of the digital twin 210 may provide a function, data, and/or a service related to the object of interest 260, which is an object observable by the digital twin 210. The FOF of the digital twin 210 may discover one or more other digital twins to federate with the digital twin 210. The FOF of the digital twin 210 may determine, from among the discovered digital twins, a digital twin to form a digital twin federation. The FOF of the digital twin 210 may establish a communication connection with the determined digital twin and form the digital twin federation.

For example, in FIG. 2, the FOF of the digital twin 210 may discover feature information of another digital twin registered in the registry 230. The FOF of the digital twin 210 may determine a digital twin to form a digital twin federation using the feature information of another digital twin.

The FOF of the digital twin 210 may establish a direct communication connection with the determined digital twin or establish an indirect communication connection with the determined digital twin using the communication adaptor 240.

In the example described above, “interaction” may imply that components are connected to each other for communication and may transmit and/or receive data.

For example, a digital twin may be a digital representation of an observable object and may be synchronized with the object (at an appropriate rate).

For example, connection information may be information used for establishing the connection between digital twins. For example, the connection information may include information required for a communication connection, such as a protocol, a uniform resource identifier (URI), an internet protocol (IP) address, a port number, and the like.

For example, feature information may be a description of a digital twin. For example, the feature information may include data or a function that may be provided and semantic information for each data and function.

For example, digital twin federation may represent sharing an application context for collaboration across different digital twins. For example, an entity generated as a result of digital twin federation may be referred to as a federated digital twin.

According to an embodiment, the digital twin 210, the registry 230, and the communication adaptor 240 may each operate on separate electronic devices. For example, the digital twin 210 may operate by being implemented on a first electronic device, the registry 230 may operate by being implemented on a second electronic device, and the communication adaptor 240 may operate by being implemented on a third electronic device. The first, second, and third electronic devices may establish communication with one another via a wireless and/or wired network. Depending on an embodiment, the registry 230 and the communication adaptor 240 may operate by being implemented on the same electronic device.

An electronic device may include a processor and a memory for storing instructions. When executed by the processor, the instructions may cause the electronic device to perform operations described herein. For example, the electronic device may include various computing devices, such as a mobile phone, a smartphone, a tablet personal computer (PC), an electronic book (e-book) device, a laptop computer, a PC, a desktop, a workstation, or a server, various wearable devices, such as a smart watch, smart eyeglasses, a head-mounted display (HMD), or smart clothing, various home appliances, such as a smart speaker, a smart television (TV), or a smart refrigerator, and other devices, such as a smart car, a smart kiosk, an Internet of things (IoT) device, a walking assist device (WAD), a drone, or a robot.

FIG. 3 is a schematic block diagram of a digital twin, according to various embodiments.

Referring to FIG. 3, a digital twin 300 according to various embodiments may include GF 310 in which the digital twin provides a service through a standalone application and FOF 320 in which the digital twin provides a service through a federated application by controlling and managing digital twin federation operations from the beginning to the end.

For example, the FOF 320 may include an FM-FE 321, an FIM-FE 322, an FSIM-FE 323, a CFIM-FE 324, an FC-FE 325, and a CSIM-FE 326.

In FIG. 3, FO-A may indicate the reference point between the FM-FE 321 and a federated application (or a predetermined FE of the federated application). When there are multiple FEs interacting between the FM-FE 321 and the federated application (or the predetermined FE of the federated application), the FM-FE 321 may have multiple FO-A reference points.

In FIG. 3, FO-G may indicate the reference point between the FM-FE 321 and the GF 310. When the GF 310 have multiple FEs interacting with the FM-FE 321, the FM-FE 321 may have a plurality of FO-G reference points.

In FIG. 3, FO-FO may indicate the reference point between FC-FEs (e.g., FC-FE 325) of a digital twin federation (e.g., between the FC-FE 325 of the digital twin 300 and an FC-FE of another digital twin).

In FIG. 3, FO-FCS 1 may indicate the reference point between the FIM-FE 322 and a digital twin registration FE of a registry 400. FO-FCS 2 may indicate the reference point between the CFIM-FE 324 and a digital twin discovery FE of a registry.

In FIG. 3, FO-CAS may indicate the reference point between the FC-FE 325 and an adaptation process FE of a communication adaptor.

For example, the GF 310 may provide a function required for a standalone service provided by the digital twin 300. For example, the GF 310 may include various FEs according to the standalone service provided by the digital twin 300 and an object of interest observed by the digital twin 300.

Since the GF 310 provides a function for the digital twin 300 to provide a service through a standalone application, FEs possessed by the GF 310 are not defined herein. However, the GF 310 may have one or more FEs to provide its own resources, that is, data and functions, under the control of the FOF 320 during a digital twin federation process.

The GF 310 may be controlled by the FOF 320. For example, the GF 310 may provide data and a function of the digital twin 300 for a digital twin federation under the control of the FOF 320.

For example, the FM-FE 321 may start and orchestrate digital twin federation.

The FM-FE 321 may interact with the CFIM-FE 324 to search for other digital twins to federate with.

The interaction between a predetermined FE and another FE may involve operations such as performing data communication with another FE, transmitting a request for performing a predetermined operation or processing predetermined data to another FE, and/or controlling another FE.

For example, when predefined members of a digital twin federation are determined and each digital twin feature information is shared, the FM-FE 321 may search for the feature information of another digital twin without interacting with the CFIM-FE 324.

The FM-FE 321 may interact with the CFIM-FE 324 to determine a digital twin to federate with from among the one or more searched for digital twins.

The FM-FE 321 may interact with the FC-FE 325 to start communication with the determined digital twin.

The FM-FE 321 may interact with the FC-FE 325 to exchange data and/or information with a digital twin included in a federation.

The FM-FE 321 may utilize the data and/or functions of the digital twin 300 by interacting with the GF 310 and may utilize the data and/or functions of another digital twin obtained through the FC-FE 325.

The FM-FE 321 may provide data to a federated application 620.

The FM-FE 321 may interact with the FSIM-FE 323 to manage the identifier of a digital twin participating in a digital twin federation and the federation status of the digital twin federation including data and/or a function provided by each digital twin.

For example, the FM-FE 321 may provide a function for providing data and/or a function by participating in the digital twin federation.

The FM-FE 321 may interact with the FSIM-FE 322 to register the feature information of the digital twin 300.

For example, when the predefined members of the digital twin federation are determined and feature information of each digital twin is shared, the FM-FE 321 may not interact with the CFIM-FE 324 and may not register feature information in the registry 400.

The FM-FE 321 may process a data and/or function request received through the FC-FE 325.

The FM-FE 321 may interact with the GF 310 to obtain the requested data and/or the result of the requested function (from another digital twin included in the digital twin federation).

The FM-FE 321 may interact with the FC-FE 325 to transmit the requested data and/or the result of the requested function to another digital twin (e.g., a digital twin that transmits the requested data and/or function).

The FM-FE 321 may interact with the FSIM-FE 323 to manage the identifier of the digital twin participating in the digital twin federation and the status of the digital twin federation including the data and/or function provided by the digital twin.

When digital twins share feature information in a manner not described herein, the FM-FE 321 may not perform discovery through the CFIM-FE 324.

In order to participate in the digital twin federation and provide data and a function, the FM-FE 321 may provide the following functions related to federation management. For example, the FM-FE 321 may interwork with the FIM-FE 322 to register its feature information. The FM-FE 321 may process a request received through the FC-FE 325. The FM-FE 321 may interwork with the GF 310 to obtain the requested data or the result of the requested function. The FM-FE 321 may interwork with the FC-FE 325 to transmit the requested data or the result of the requested function. The FM-FE 321 may interwork with the FSIM-FE 323 to manage the identification (ID) of the participating digital twin and federation status information including the data and function provided by the FM-FE 321.

When the digital twins share feature information in a manner not described herein, the FM-FE 321 may not register the feature information through the FIM-FE 322.

For both of the preceding two cases, the FM-FE 321 may provide the following functions related to federation management. For example, the FM-FE 321 may interwork with the FIM-FE 322 to generate or modify its feature information based on information obtained through the GF 310 or the federated application.

When initiating, orchestrating, or participating in a digital twin federation, the FM-FE 321, in relation to digital twin federation management, may generate or modify the feature information of the digital twin 300 by interacting with the FSIM-FE 323, based on the information obtained from the GF 310 and/or the federated application.

For example, the FSIM-FE 323 may provide a function related to a status of the digital twin federation.

The FSIM-FE 323 may generate digital twin federation status information being activated through interaction with the FM-FE 321.

The FSIM-FE 323 may maintain or mange the identifier (e.g., ID) of the digital twin participating in the digital twin federation and the status information of the digital twin federation including data and/or a function provided by each digital twin.

The FSIM-FE 323 may remove the status information of the digital twin federation when the digital twin federation is terminated.

For example, the FIM-FE 322 may provide a function related to feature information.

The FIM-FE 322 may generate the feature information by interacting with the FM-FE 321.

The FIM-FE 322 may maintain or manage the generated feature information.

The FIM-FE 322 may modify the feature information under the control of the FM-FE 321.

The FIM-FE 322 may interact with the registry to register the feature information of the digital twin 300 under the control of the FM-FE 321.

For example, the CFIM-FE 324 may provide a function related to the feature information obtained from the registry.

The CFIM-FE 324 may interact with the registry under the control of the FM-FE 321 to discover another digital twin for performing the digital twin federation.

The CFIM-FE 324 may maintain and/or manage feature information of other digital twins.

The CFIM-FE 324 may provide feature information and connection information by interacting with the FM-FE 321 and/or the FC-FE 325. For example, the CFIM-FE 324 may provide feature information and/or connection information of another digital twin received through the FC-FE 325 to the FM-FE 321.

For example, the FC-FE 325 may provide a function related to communication.

The FC-FE 325 may establish communication between another digital twin and the digital twin 300 under the control (or orchestration) of the FM-FE 321.

The FC-FE 325 may interact with the CFIM-FE 324 to obtain connection information of a digital twin to be connected for communication.

When direct communication with another digital twin is unavailable, the FC-FE 325 may establish an indirect communication connection with another digital twin by interacting with a communication adaptor 500.

For example, while the digital twin 300 and another digital twin (e.g., digital twin B of FIG. 1) may use the same protocol, direct communication with another digital twin may not be supported due to the internal settings or policies of the digital twin 300. This scenario represents a case where direct communication with another digital twin is unavailable.

For example, when the digital twin 300 and another digital twin (e.g., digital twin B of FIG. 1) use different protocols, adaptation may be required. This scenario represents a case where direct communication with another digital twin is unavailable.

The FC-FE 325 may exchange data and/or a function and information about the data and/or the result of the function through direct or indirect communication with another digital twin.

The FC-FE 325 may interact with the CSIM-FE 326 to maintain or remove status information regarding communication with another digital twin.

For example, the CSIM-FE 326 may provide a function related to the management of communication status management.

The CSIM-FE 326 may generate communication status information being activated by interacting with the FC-FE 325.

The CSIM-FE 326 may maintain and/or manage status information of the identifier, a communication type (e.g., direct communication or indirect communication through a communication adaptor), and the like of another digital twin with which communication is established.

The CSIM-FE 326 may remove the status information about communication with another digital twin under the control of the FC-FE 325.

FIG. 4 is a schematic block diagram of the registry 400, according to various embodiments.

Referring to FIG. 4, the registry 400 may include FCSF 410. The FCSF 410 may include a DTR-FE 411, an SD-FE 412, and a DTD-FE 413.

In FIG. 4, FO-FCS 1 may indicate the reference point between the DTR-FE 411 and an FIM-FE of the FOF 220.

FO-FCS2 may indicate the reference point between the DTD-FE 413 and a CFIM-FE of the FOF 220.

The FCSF 410 may interact with FOF of a digital twin and/or another digital twin to provide a function for discovering yet another digital twin for a digital twin federation.

For example, the DTR-FE 411 may provide a function related to the registration of a digital twin.

The DTR-FE 411 may register the feature information of the digital twin according to a request for registration from the digital twin.

The DTR-FE 411 may store and/or manage the registered feature information of the digital twin.

The DTR-FE 411 may provide semantic information included in the feature information to the SD-FE 412. The DTR-FE 411 may provide the feature information of the digital twin requested from the DTD-FE 413.

For example, the SD-FE 412 may provide a function related to a semantic dictionary which has the mapping among synonyms or words in different languages.

The SD-FE 412 may generate the semantic dictionary using semantic information provided by the DTR-FE 411.

The SD-FE 412 may provide the semantic information to the DTD-FE 413.

The SD-FE 412 may maintain and manage the generated semantic dictionary.

For example, the DTD-FE 413 may provide a function related to the search and discovery of a digital twin.

The DTD-FE 413 may interwork with the DTR-FE 411 to find a digital twin that satisfies a predetermined condition provided by a digital twin that starts federation.

The DTD-FE 413 may find an appropriate digital twin (e.g., the digital twin that satisfies the predetermined condition provided by the digital twin that starts federation) by interacting with the SD-FE 412.

The DTD-FE 413 may provide feature information of the searched for digital twin to the digital twin that requests the search and discovery of a digital twin.

FIG. 5 is a schematic block diagram of the communication adaptor 500, according to various embodiments.

Referring to FIG. 5, the communication adaptor 500 may include CASF 510. The CASF 510 may include an AP-FE 511, a PA-FE 512, a DFA-FE 513, and an SA-FE 514.

The CASF 510 may interwork with FOF of a digital twin to provide a function for establishing a communication connection between digital twins that may not be directly connected to each other or may not communicate directly with each other.

In FIG. 5, FO-CAS may indicate the reference point between the AP-FE 511 and an FC-FE.

For example, the AP-FE 511 may provide a function related to adaptation processing. For example, adaptation processing may represent conversion of protocols, data formats, and the like of messages, data, and the like received from a digital twin into messages, data, and the like that are identifiable by another digital twin.

The AP-FE 511 may determine whether an adaptation request from a digital twin is acceptable and respond to the digital twin that requests adaptation.

The AP-FE 511 may process adaptation by interacting with the PA-FE 512, the DFA-FE 513, and/or the SA-FE 514.

The AP-FE 511 may generate and manage adaptation status information being activated.

The AP-FE 511 may transmit an adapted message (e.g., a message with converted data format, protocol, etc.) to a digital twin which is the recipient of the message.

The adaptation status information may include ID information, an adaptation type, and the like of each digital twin. The ID information may include an ID, access information (e.g., IP address and port number), and the like of each digital twin.

For example, the PA-FE 512 may provide a function related to PA (or protocol conversion).

The PA-FE 512 may perform PA (or protocol conversion) under the control of the AP-FE 511.

PA may include an operation of converting a message format of a protocol used by a source digital twin (e.g., a digital twin that sends a message) into a message format used by a digital twin which is the recipient of the message. PA may include an operation of performing a computation of a protocol used by each digital twin.

For example, the DFA-FE 513 may provide a function related to DFA.

The DFA-FE 513 may perform the DFA under the control of the AP-FE 511.

The DFA may be the conversion of a data format used by a digital twin that transmits a message into a data format used by a digital twin that receives a message, such as the conversion of XML into JSON. In addition, the DFA may include an operation of converting a data format used by an original digital twin (e.g., a digital twin that sends a message) into a data format used by a digital twin which is the recipient of the message.

For example, the SA-FE 514 may provide a function related to SA.

The SA-FE 514 may perform SA under the control of the AP-FE 511.

The SA may include an operation of converting a term used in a digital twin into a term used in another digital twin.

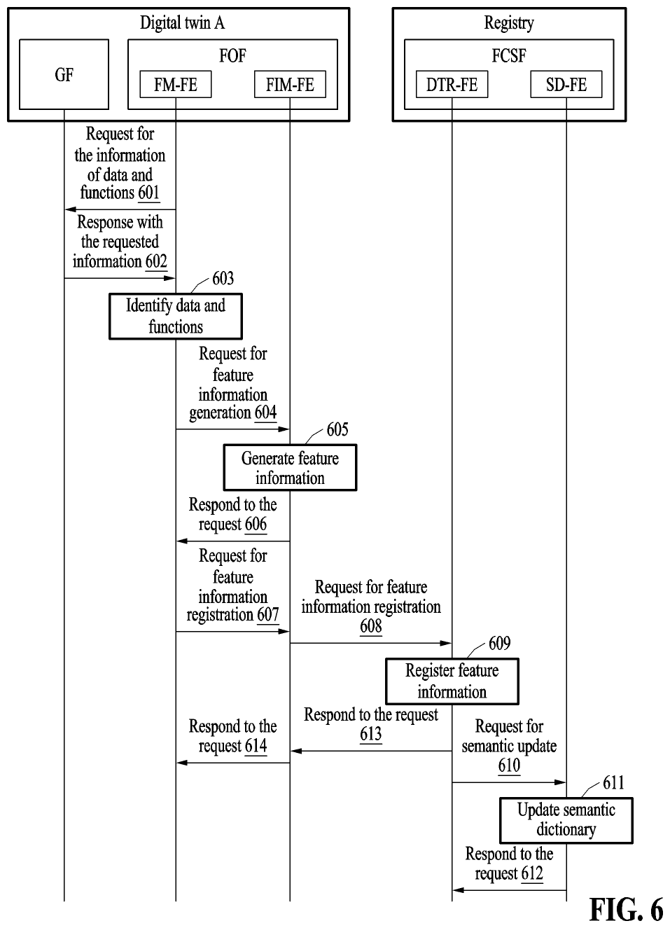

The procedures exemplarily illustrated in FIGS. 6 to 11C may undergo some modifications based on whether FEs included in functions are integrated or divided, according to the implementation approach of a digital twin federation.

FIG. 6 is a diagram illustrating an operation of a digital twin (e.g., digital twin A) to register feature information in a registry, according to various embodiments.

A digital twin (e.g., digital twin A, digital twin B, etc.) may register feature information in a registry to participate in digital twin federation.

An FM-FE of FOF may generate feature information by interacting with GF.

The FM-FE may transmit a request for information to the GF in operation 601 and may receive the information in operation 602. In operation 603, the FM-FE may identify data and a function based on the received information. For example, the information may include data, a function, and the like for generating the feature information. For example, the FM-FE may transmit the request for information to the GF through a FO-G reference point.

In operation 604, the FM-FE may transmit the request for feature information generation to an FIM-FE. The FM-FE may transmit the request to the FIM-FE along with the data and function received from the GF. In operation 605, the FIM-FE may generate feature information. For example, the FIM-FE may generate the feature information under the control of the FM-FE. The FIM-FE may generate the feature information including semantic information. In operation 606, the FIM-FE may transmit a response to the FM-FE to notify that the feature information is generated.

In operation 607, the FM-FE may transmit a request for feature information registration to the FIM-FE by interacting with the FIM-FE. In operation 608, the FIM-FE may transmit the request for feature information registration to the registry. For example, the FIM-FE may transmit the request for feature information registration through an FO-FCS1 reference point by interacting with the registry or a DTR-FE of the registry.

In operation 609, the DTR-FE of the registry may receive the request including the feature information and maintain the registered feature information of the digital twin.

In operation 610, the DTR-FE may transmit a request for semantic information update to an SD-FE. The DTR-FE may transmit semantic information included in the feature information to the SD-FE. In operation 611, the SD-FE may perform a semantic update using the received semantic information. The SD-FE may update a semantic dictionary. In operation 612, the SD-FE may transmit a response to the request for semantic update to the DTR-FE.

The DTR-FE may transmit a response to the request for feature information registration to the FIM-FE in operation 613. The FIM-FE may transmit a response to the request for feature information registration to the FM-FE in operation 614. The response to the request for feature information registration may be a signal that notifies that feature information registration is successfully completed.

The embodiment illustrated in FIG. 6 may represent an embodiment in which a digital twin registers its own feature information in a registry to discover the feature information of another digital twin registered in the registry in order to form a digital twin federation.

According to an embodiment, when a digital twin federation is formed with predefined members, each digital twin may not register its own feature information in the registry. Each digital twin may receive, input, and store the feature information of the predefined members in various ways.

According to another embodiment related to the registration of feature information among digital twins, unlike digital twin federation using a registry, static digital twin federation may be performed using predefined members. In this case, there is no need to register feature information in the registry. However, each digital twin may need to generate corresponding feature information and share generated functional information through some techniques not included herein.

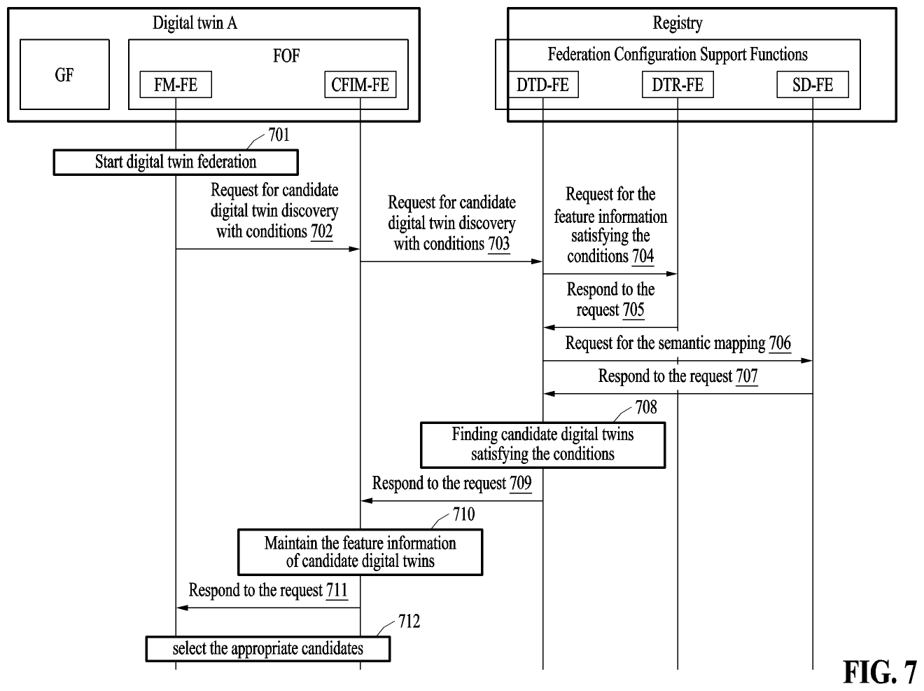

FIG. 7 is a diagram illustrating an operation of a digital twin to discover feature information registered in a registry, according to various embodiments.

Before starting digital twin federation, a digital twin intending to start federation may need to search for a candidate digital twin (e.g., the other digital twin 220 of FIG. 2) to participate in the federation. FIG. 7 is a diagram illustrating an example of an operation of digital twin A to search for a candidate digital twin corresponding to a member of a digital twin federation.

For example, when a digital twin federation is formed with predefined members, operations of the digital twin A, as illustrated in FIG. 7, to discover a candidate digital twin may not be performed.

In operation 701, an FM-FE may start digital twin federation. The FM-FE may start the digital twin federation under the control of a federated application that interacts through an FO-A reference point.

In operation 702, the FM-FE may transmit a request for the discovery of candidate digital twins to a CFIM-FE. In operation 703, the CFIM-FE may transmit the request for the discovery of candidate digital twins to a DTD-FE. In operation 703, the CFIM-FE may transmit, to the DTD-FE, a request including a predetermined condition to discover candidate digital twins for digital twin federation.

The DTD-FE may find candidate digital twins matching the received condition by referring to feature information and semantic information stored in a DTR-FE and an SD-FE, respectively.

The DTD-FE may transmit a request for the feature information of the candidate digital twins to the DTR-FE in operation 704 and may receive the feature information from the DTR-FE in operation 705.

The DTD-FE may transmit a request for semantic mapping to the SD-FE in operation 706 and receive the semantic mapping from the SD-FE in operation 707.

In operation 708, the DTD-FE may discover the candidate digital twins based on the received feature information and semantic mapping.

In operation 709, the DTD-FE may transmit a response to the request for the discovery of candidate digital twins to the CFIM-FE. In operation 709, the DTD-FE may transmit, to the CFIM-FE, the feature information of a candidate digital twin discovered to be suitable for the condition in operation 708.

In operation 710, the CFIM-FE may maintain the feature information of the candidate digital twins. In operation 710, the CFIM-FE may store the feature information of a digital twin discovered to be suitable for the condition.

In operation 711, the CFIM-FE may transmit a response to the FM-FE. In operation 711, the CFIM-FE may transmit a response to the request for candidate discovery to the FM-FE.

In operation 712, the FM-FE may select an appropriate candidate digital twin by interacting with the CFIM-FE. The FM-FE may determine another digital twin satisfying the condition for forming a digital twin federation by interacting with the CFIM-FE.

The FM-FE may interact with a federated application through an FO-A reference point to determine another digital twin to form a digital twin federation.

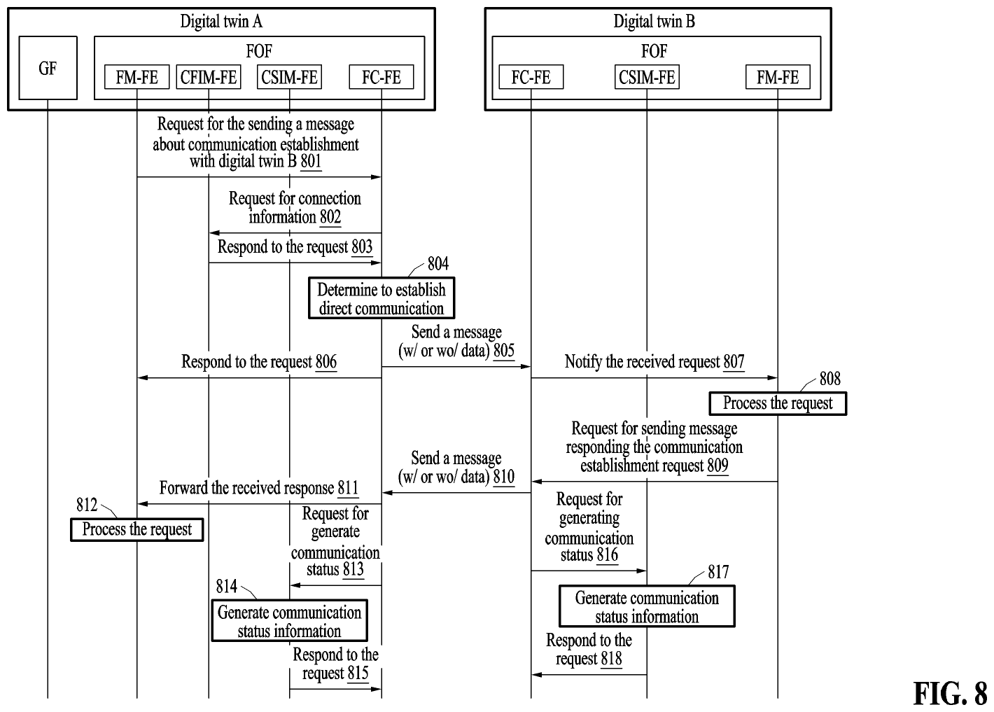

FIG. 8 is a diagram illustrating an operation of a digital twin to establish a communication connection with another digital twin, according to various embodiments.

A digital twin (e.g., digital twin A) that starts digital twin federation may establish a direct communication connection with another digital twin (e.g., digital twin B) based on feature information of each digital twin. For example, when each digital twin uses the same communication protocol, the same data format, and the common semantic, the digital twin A may establish a direct communication connection with the digital twin B. The digital twin A may determine whether the protocols and data formats are the same based on feature information.

In operation 801, an FM-FE may transmit a communication connection request to an FC-FE. The communication connection request may include the identifier of another digital twin.

In operation 802, the FC-FE may transmit a request for connection information to a CFIM-FE. In operation 802, the FC-FE may transmit a request for feature information to the CFIM-FE. For example, the FC-FE may transmit a request for connection information and/or feature information using the identifier of another digital twin included in the communication connection request.

In operation 803, the FC-FE may receive connection information from the CFIM-FE. In operation 803, the FC-FE may receive the feature information of another digital twin from the CFIM-FE. For example, the FC-FE may receive the connection information and/or feature information of a digital twin corresponding to the identifier of the digital twin that transmits the request.

In operation 804, the FC-FE may determine to establish a direct connection with another digital twin, based on the connection information and/or feature information. For example, when the digital twin A and the digital twin B use the same protocol, the same data format, and the common semantic, the FC-FE may determine to establish a direct communication connection with the digital twin B in operation 804.

In operation 805, the FC-FE may transmit a response to the communication connection request to the FM-FE. The response may include information about the type of communication connection (e.g., a direct connection or indirect connection).

In operation 806, the FC-FE may transmit a message to an FC-FE of the digital twin B. For example, the message may include a request to establish a communication connection between the digital twin A and the digital twin B.

In operation 807, the FC-FE may transmit, to an FM-FE, a notification that the request is received. In operation 808, the FM-FE may process the request. For example, the FM-FE may determine whether to accept a communication connection according to the request.

In operation 809, the FM-FE may transmit a request for message transmission to the FC-FE.

In operation 810, the FC-FE may transmit a message to the FC-FE.

In operation 811, the FC-FE may transmit the received message to the FM-FE.

In operation 812, the FM-FE may process a response based on the received message.

In operation 813, the FC-FE may transmit a request for communication status generation to the CSIM-FE.

In operation 814, the CSIM-FE may generate a communication status according to the received request.

In operation 815, the FC-FE may receive a response including the communication status.

In operation 816, the FC-FE may transmit a request for communication status generation to the CSIM-FE.

In operation 817, the CSIM-FE may generate a communication status according to the received request.

In operation 818, the FC-FE may receive a response including the communication status.

For example, based on the responses in operations 815 and 818, the FC-FE may establish communication between the digital twin A and the digital twin B.

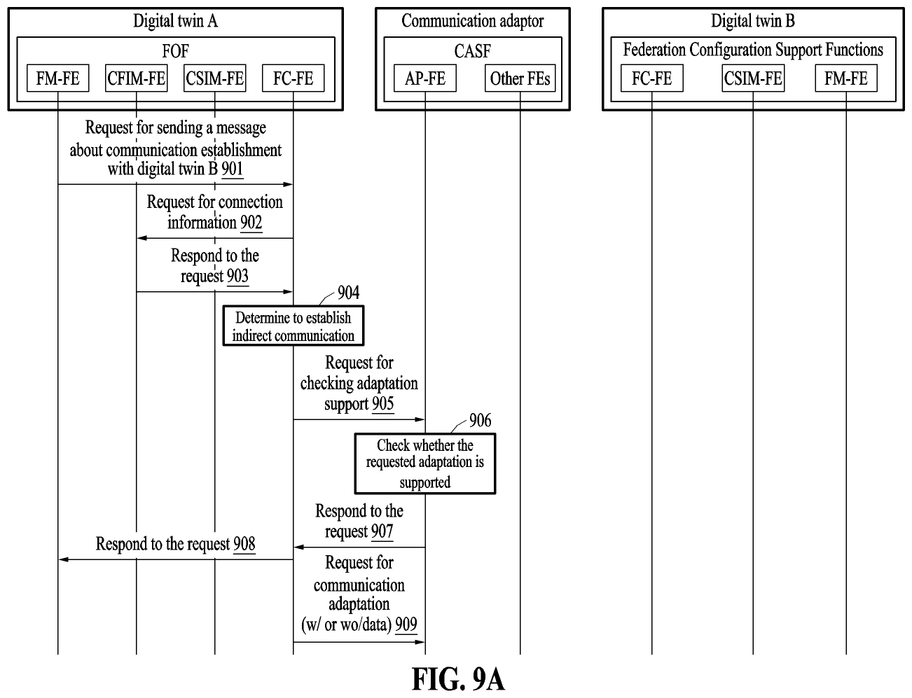

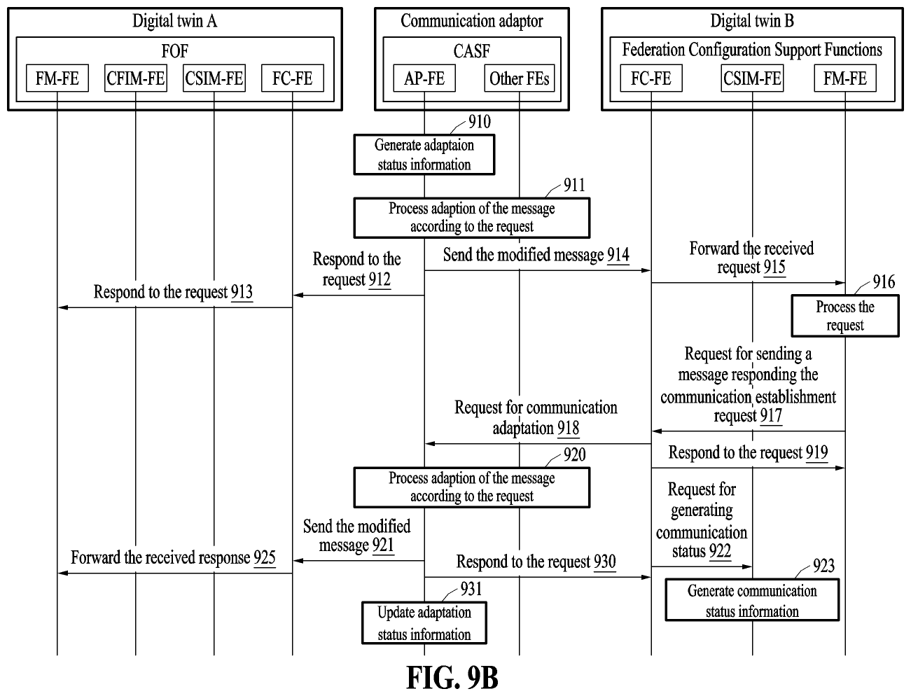

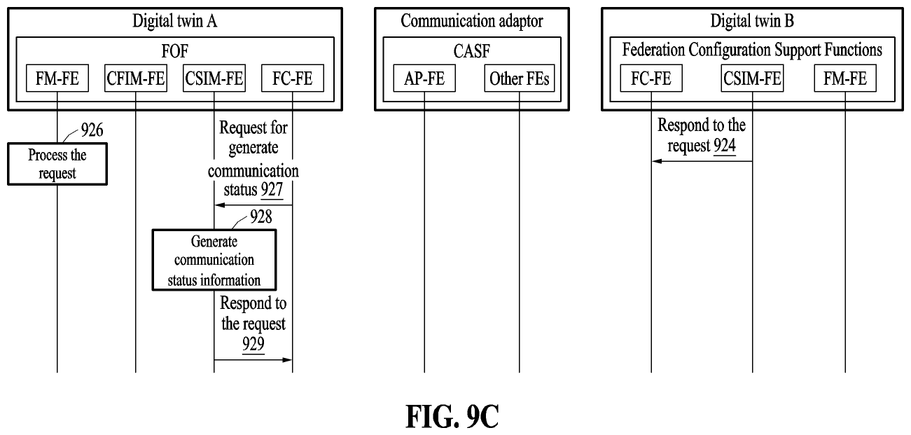

FIGS. 9A, 9B, and 9C are diagrams illustrating an operation of a digital twin (e.g., digital twin A) to establish a communication connection with another digital twin (e.g., digital twin B) using a communication adaptor, according to various embodiments.

When the communication protocol and/or data format of the digital twin B to form a digital twin federation is different from the communication protocol and/or data format of the digital twin A, the digital twin A may establish an indirect communication connection with the digital twin B using a communication adaptor.

In operation 901, an FM-FE may transmit a communication connection request to an FC-FE. The communication connection request may include the identifier of another digital twin.

In operation 902, the FC-FE may transmit a request for connection information to a CFIM-FE. In operation 902, the FC-FE may transmit a request for feature information to the CFIM-FE. For example, the FC-FE may transmit a request for connection information and/or feature information using the identifier of another digital twin included in the communication connection request.

In operation 903, the FC-FE may receive connection information from the CFIM-FE. In operation 903, the FC-FE may receive the feature information of another digital twin from the CFIM-FE. For example, the FC-FE may receive the connection information and/or feature information of a digital twin corresponding to the identifier of the digital twin that transmits the request.

In operation 904, the FC-FE may determine the type of communication connection as an indirect connection. For example, when the digital twin A and the digital twin B use different communication protocols, data formats, or semantics, the FC-FE may determine to establish an indirect communication connection with the digital twin B using the communication adaptor.

In operation 905, the FC-FE may transmit a request to check for adaptation support to an AP-FE. The request transmitted by the FC-FE to the AP-FE in operation 905 may include information about a protocol, data format, or semantic that requires adaptation (or conversion).

In operation 906, the AP-FE may check whether adaptation support is available. The AP-FE may determine whether adaptation (or conversion) requested by the digital twin A is supported by the communication adaptor.

In operation 907, the AP-FE may transmit a response to the request to check for adaptation support to the FC-FE. The response to the request to check for adaptation support may include a result obtained by checking whether adaptation support is available. In operation 908, the FC-FE may transmit a response to the communication connection request to the FM-FE.

In operation 909, the FC-FE may transmit a communication adaptation request (or connection establishment request) to the AP-FE.

In operation 910, the AP-FE may generate adaptation status information.

In operation 911, the AP-FE and other FEs may process the adaptation of a message. For example, other FEs may include a PA-FE, a DFA-FE, and an SA-FE.

Message adaptation processing may include converting a communication protocol, a data format, and/or semantic information of a message.

In operation 912, the AP-FE may transmit a response (to the request from operation 909) to the FC-FE. In operation 913, the FC-FE may transmit the received response to the FM-FE.

In operation 914, the AP-FE may transmit a modified message to an FC-FE of the digital twin B. The AP-FE may process the requested adaptation and transmit the processed communication establishment request to the FC-FE.

In operation 915, the FC-FE may transmit the modified message to an FM-FE.

In operation 916, the FM-FE may process the request. For example, the FM-FE may process the request by processing the modified message. The request may represent a request regarding a communication connection received from the digital twin A via the communication adapter.

In operation 917, the FM-FE may transmit a request for message transmission to the FC-FE.

In operation 918, the FC-FE may transmit the communication adaptation request (or the response to the connection establishment request) to the AP-FE.

In operation 919, the FC-FE may transmit a response (to the request from operation 917) to the FM-FE.

In operation 920, the AP-FE and other FEs may process adaptation of the message. The AP-FE may process the received response.

In operation 921, the AP-FE may transmit the modified message to the FC-FE of the digital twin A.

In operation 922, the FC-FE may transmit a request for communication status generation to a CSIM-FE.

In operation 923, the CSIM-FE may generate a communication status according to the received request.

In operation 924, the FC-FE may receive a response including a communication status from the CSIM-FE.

In operation 925, the FC-FE may transmit the modified message to the FM-FE.

In operation 926, the FM-FE may process the request. For example, the FM-FE may process the request by processing the modified message. The request may represent a request regarding a communication connection (or a response to the communication connection request) received from the digital twin B via the communication adaptor.

In operation 927, the FC-FE may transmit a request for communication status generation to the CSIM-FE.

In operation 928, the CSIM-FE may generate communication status information according to the received request.

In operation 929, the FC-FE may receive a response including the communication status from the CSIM-FE.

In operation 930, the AP-FE may transmit the response to the FC-FE. Here, the response may be a response to the communication adaptation request from operation 918.

In operation 931, the AP-FE may update adaptation status information.

For example, depending on the responses in operations 929 and 924, the FC-FEs of the digital twins A and B may establish communication between the digital twin A and the digital twin B via the communication adapter.

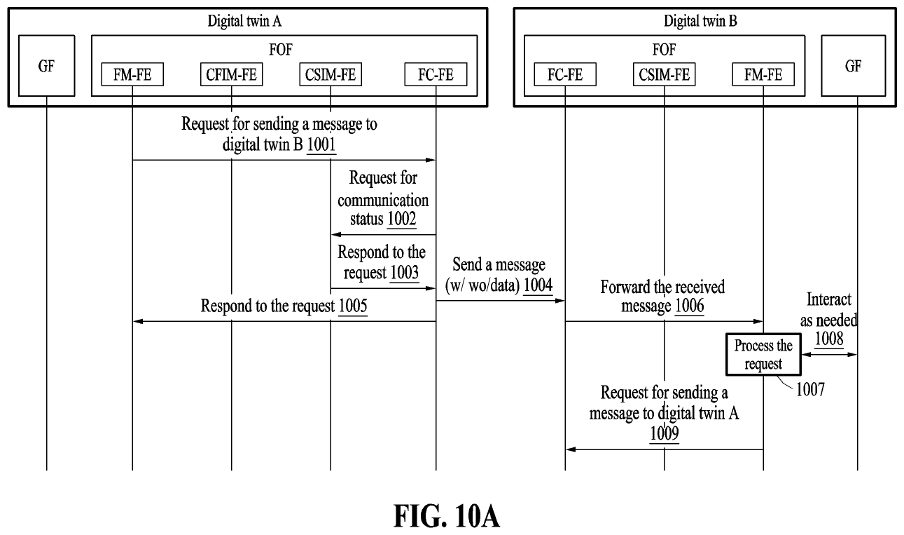

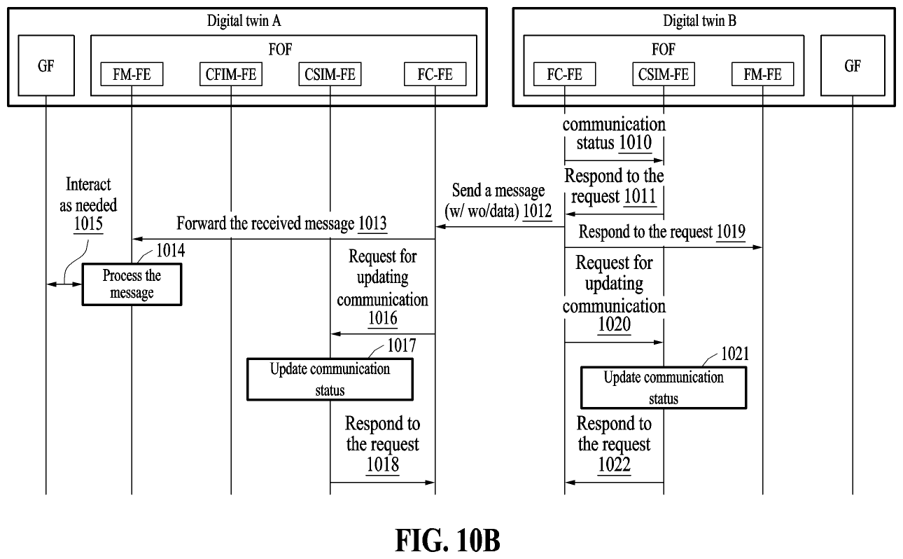

FIGS. 10A and 10B are diagrams illustrating an operation of a digital twin (e.g. digital twin A) to perform data communication with another digital twin (e.g., digital twin B), according to various embodiments.

For example, as illustrated in FIG. 8, when communication between digital twins is established (or a digital twin federation is formed), the digital twin A or the digital twin B may transmit data, a request for data transmission, and/or a request for the result of functions to another digital twin.

FIGS. 10A and 10B are diagrams illustrating an example of the digital twin A interacting with an FC-FE to fetch data in an example in which the digital twin A needs data from the digital twin B.

In operation 1001, an FM-FE may transmit a request for message transmission to an FC-FE.

In operation 1002, the FC-FE may transmit a request to a CSIM-FE to check a communication status.

In operation 1003, a CSIM-FE may transmit information about the communication status to the FC-FE.

In operation 1004, the FC-FE may transmit a message to an FC-FE.

In operation 1005, the FC-FE may transmit a response to the request for message transmission (from operation 1001) to the FM-FE.

In operation 1006, the FC-FE may transmit a message to the FM-FE.

In operation 1007, the FM-FE may process the message. The message may include requests for data, functions, and the like directed to the digital twin B.

In operation 1008, the FM-FE may interact with GF. For example, when interaction with the GF is needed to process the received message, the FM-FE may process the message by interacting with the GF. For example, the FM-FE may interact with the GF via an FO-G reference point and fetch data.

In operation 1009, the FM-FE may transmit a request for message transmission to the FC-FE.

In operation 1010, the FC-FE may transmit a request to a CSIM-FE to check the communication status.

In operation 1011, the CSIM-FE may transmit information about the communication status to the FC-FE.

In operation 1012, the FC-FE may transmit a message to the FC-FE.

In operation 1013, the FC-FE may transmit the message to the FM-FE.

In operation 1014, the FM-FE may process the message. The message may include data received from the digital twin B, the result of a function request, and the like.

In operation 1015, the FM-FE may interact with the GF. For example, when interaction with the GF is needed to process the received message, the FM-FE may process the message by interacting with the GF. For example, the FM-FE may interact with the GF via the FO-G reference point and fetch data.

In operation 1016, the FC-FE may transmit a request for a communication status update to the CSIM-FE.

In operation 1017, the CSIM-FE may update a communication status.

In operation 1018, the CSIM-FE may transmit a response (to the request from operation 1016) to the FC-FE. The response may include information about an updated communication status.

In operation 1019, the FC-FE may transmit a response to the request for message transmission (from operation 1009) to the FM-FE.

In operation 1020, the FC-FE may transmit a request for a communication status update to the CSIM-FE.

In operation 1021, the CSIM-FE may update a communication status.

In operation 1022, the CSIM-FE may transmit a response (to the request from operation 1020) to the FC-FE. The response may include information about an updated communication status.

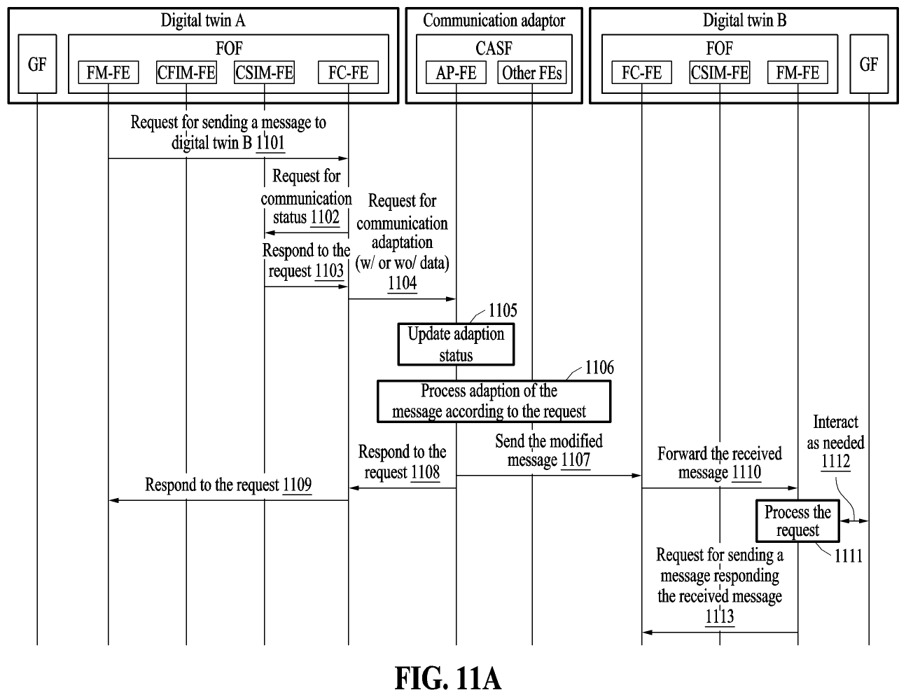

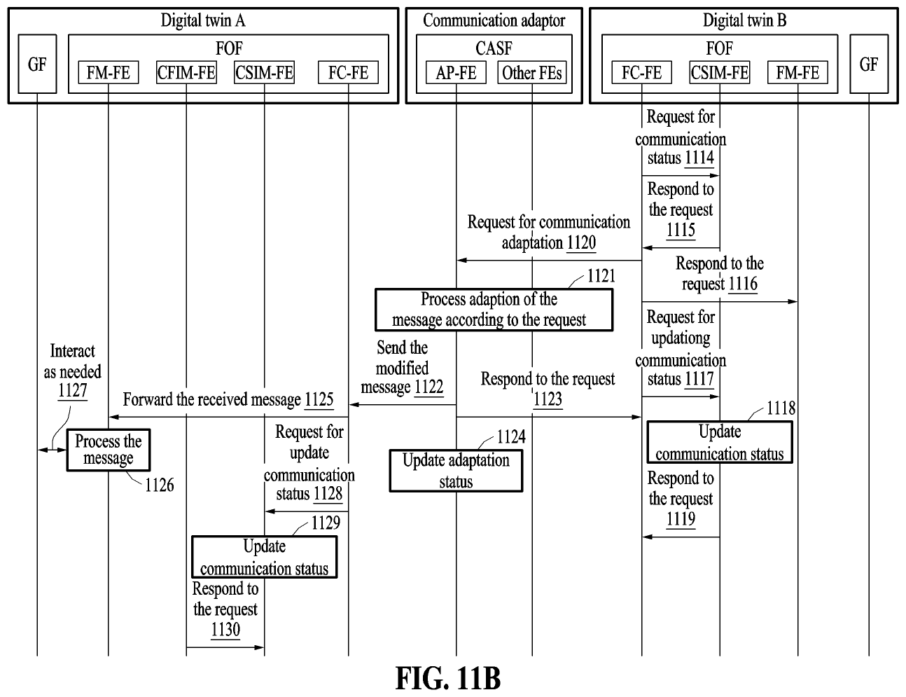

FIGS. 11A and 11B are diagrams illustrating an operation of a digital twin (e.g., digital twin A) to perform data communication with another digital twin (e.g., digital twin B) using a communication adaptor, according to various embodiments.

For example, as illustrated in FIGS. 9A, 9B, and 9C, when communication between digital twins is established (or a digital twin federation is formed) via the communication adaptor 500, the digital twin A or the digital twin B may transmit data, a request for data transmission, and/or a request for a result of a function to another digital twin.

In operation 1101, an FM-FE may transmit a request for message transmission to an FC-FE.

In operation 1102, the FC-FE may transmit a request to a CSIM-FE to check a communication status.

In operation 1103, the CSIM-FE may transmit information about the communication status to the FC-FE.

In operation 1104, the FC-FE may transmit a request for communication adaptation to an AP-FE.

In operation 1105, the AP-FE may update an adaptation status.

In operation 1106, the AP-FE and other FEs may process adaptation of a message according to the request. For example, other FEs may include a PA-FE, a DFA-FE, and an SA-FE.

Message adaptation processing may include converting a communication protocol, a data format, and/or semantic information of a message.

In operation 1108, the AP-FE may transmit a response (to the request from operation 1104) to the FC-FE. In operation 1109, the FC-FE may transmit the received response to the FM-FE.

In operation 1107, the AP-FE may transmit a modified message to an FC-FE of the digital twin B. The AP-FE may process the requested adaptation and transmit a processed communication establishment request to the FC-FE.

In operation 1110, the FC-FE may transmit the modified message to an FM-FE.

In operation 1111, the FM-FE may process the message. The message may include requests for data, functions, and the like directed to the digital twin B.

In operation 1112, the FM-FE may interact with GF. For example, when interaction with the GF is needed to process the received message, the FM-FE may process the message by interacting with the GF. For example, the FM-FE may interact with the GF via the FO-G reference point and fetch data.

In operation 1113, the FM-FE may transmit a request for message transmission to the FC-FE.

In operation 1114, the FC-FE may transmit a request to a CSIM-FE to check a communication status.

In operation 1115, the CSIM-FE may transmit information about the communication status to the FC-FE.

In operation 1120, the FC-FE may transmit a message to the FC-FE.

In operation 1116, the FC-FE may transmit a response to the request for message transmission (from operation 1113) to the FM-FE.

In operation 1117, the FC-FE may transmit a request for a communication status update to the CSIM-FE.

In operation 1118, the CSIM-FE may update the communication status.

In operation 1119, the CSIM-FE may transmit a response (to the request from operation 1117) to the FC-FE. The response may include information about an updated communication status.

In operation 1121, the AP-FE and other FEs may process adaptation of the message. The AP-FE may process the received response.

In operation 1122, the AP-FE may transmit the modified message to the FC-FE of the digital twin A.

In operation 1125, the FC-FE may transmit the message to the FM-FE.

In operation 1126, the FM-FE may process the message. The message may include data received from the digital twin B, the result of a function request, and the like.

In operation 1127, the FM-FE may interact with GF. For example, when interaction with the GF is needed to process the received message, the FM-FE may process the message by interacting with the GF. For example, the FM-FE may interact with the GF via the FO-G reference point and fetch data.

In operation 1128, the FC-FE may transmit a request for a communication status update to the CSIM-FE.

In operation 1129, the CSIM-FE may update the communication status.

In operation 1130, the CSIM-FE may transmit a response (to the request from operation 1128) to the FC-FE. The response may include information about an updated communication status.

In operation 1124, the AP-FE may update an adaptation status.

The method according to embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The implementations may be achieved as a computer program product, for example, a computer program tangibly embodied in a machine readable storage device (a computer-readable medium) to process the operations of a data processing device, for example, a programmable processor, a computer, or a plurality of computers or to control the operations. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory (ROM) or a random access memory (RAM), or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, for example, magnetic media such as hard disks, floppy disks, and magnetic tape, optical media such as a compact disc ROM (CD-ROM) or a digital video disk (DVD), magneto-optical media such as a floptical disk, ROM, RAM, flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific embodiments, the details should not be construed as limiting any invention or a scope that can be claimed, but rather should be construed as being descriptions of features that may be peculiar to specific embodiments of specific inventions. Specific features described in the present specification in the context of individual embodiments may be combined and implemented in a single embodiment. On the contrary, various features described in the context of a single embodiment may be implemented in a plurality of embodiments individually or in any appropriate sub-combination. Moreover, although features may be described above as acting in specific combinations and even initially claimed as such, one or more features from a claimed combination can in some cases be excised from the combination, and the claimed combination may be changed to a sub-combination or a modification of a sub-combination.

Likewise, although operations are depicted in a predetermined order in the drawings, it should not be construed that the operations need to be performed sequentially or in the predetermined order, which is illustrated to obtain a desirable result, or that all of the shown operations need to be performed. In specific cases, multi-tasking and parallel processing may be advantageous. In addition, it should not be construed that the separation of various device components of the aforementioned embodiments is required in all types of embodiments, and it should be understood that the described program components and devices are generally integrated as a single software product or packaged into a multiple-software product.

The embodiments disclosed in the present specification and the drawings are intended merely to present specific examples in order to aid in understanding of the present disclosure, but are not intended to limit the scope of the present disclosure. It will be apparent to those skilled in the art that various modifications based on the technical spirit of the present disclosure, as well as the disclosed embodiments, may be made.

What is claimed is:

1. A digital twin comprising:
general functions (GF) configured to provide a function and data of the digital twin; and
federation orchestration functions (FOF),
wherein the FOF are configured to:
discover one or more other digital twins to federate with the digital twin;
determine, from among the discovered digital twins, a digital twin to form a federated digital twin; and
form the federated digital twin by establishing a communication connection with the determined digital twin.

2. The digital twin of claim 1, wherein the FOF are configured to utilize the function and data of the digital twin by interacting with the GF or utilize data and a result received from another digital twin comprised in the federated digital twin.

3. The digital twin of claim 1, wherein the FOF are configured to manage an identifier of a digital twin comprised in the federated digital twin and a federation status of the federated digital twin.

4. The digital twin of claim 1, wherein the FOF are configured to determine a digital twin to form the federated digital twin, based on feature information of the one or more other digital twins received from a registry connected to the FOF for communication or predetermined feature information.

5. The digital twin of claim 1, wherein the FOF are configured to establish a communication connection with the determined digital twin through a communication adaptor when a direct communication connection with the determined digital twin is unavailable.

6. The digital twin of claim 1, wherein the FOF are configured to:
process a function and data requested by a digital twin comprised in the federated digital twin;
obtain a result of the requested function and data by interacting with the GF; and
transmit the result of the requested function and data to the digital twin comprised in the federated digital twin.

7. A federated digital twin comprising:
a first digital twin;
at least one second digital twin federated with the first digital twin among a plurality of digital twins other than the first digital twin; and
a registry configured to establish a communication connection with the first digital twin and the plurality of digital twins and store feature information of the first digital twin and feature information of the plurality of digital twins,
wherein each of the first digital twin and the at least one second digital twin comprises:
general functions (GF) configured to provide a function and data; and
federation orchestration functions (FOF), and
wherein the FOF of the first digital twin are configured to:
discover feature information of the plurality of digital twins registered in the registry;
determine, from among the at least one second digital twin, a digital twin to form the federated digital twin, at least based on the discovered feature information; and
form the federated digital twin by establishing a communication connection with the determined digital twin.

8. The federated digital twin of claim 7, wherein the FOF of the first digital twin are configured to utilize a function and data of the first digital twin by interacting with the GF of the first digital twin or utilize data and a result received from another digital twin comprised in the federated digital twin.

9. The federated digital twin of claim 7, wherein the FOF of the first digital twin are configured to manage an identifier of a digital twin comprised in the federated digital twin and a federation status of the federated digital twin.

10. The federated digital twin of claim 7, wherein the FOF of the first digital twin are configured to determine a digital twin to form the federated digital twin, based on feature information of the at least one second digital twin received from the registry or pre-stored feature information.

11. The federated digital twin of claim 7, wherein the FOF of the first digital twin are configured to establish a communication connection with the determined digital twin through a communication adaptor when a direct communication connection with the determined digital twin is unavailable.

12. A digital twin federation method comprising:
discovering one or more other digital twins to federate with a digital twin using federation orchestration functions (FOF) comprised in the digital twin;
determining, from among the discovered digital twins, a digital twin to form a federated digital twin using the FOF; and
using the FOF, forming the federated digital twin by establishing a communication connection with the determined digital twin.

13. The digital twin federation method of claim 12, wherein
the digital twin comprises general functions (GF) configured to provide a function and data of the digital twin, and
the digital twin federation method further comprises utilizing the function and data of the digital twin by interacting with the GF or utilizing data and a result received from another digital twin comprised in the federated digital twin.

14. The digital twin federation method of claim 12, further comprising:
managing an identifier of a digital twin comprised in the federated digital twin and a federation status of the federated digital twin using the FOF.

15. The digital twin federation method of claim 12, wherein the determining of the digital twin to form the federated digital twin comprises determining a digital twin to form the federated digital twin, based on feature information of the one or more other digital twins received from a registry connected to the FOF for communication or predetermined feature information.

16. The digital twin federation method of claim 12, wherein the forming of the federated digital twin comprises establishing a communication connection with the determined digital twin through a communication adaptor when a direct communication connection with the determined digital twin is unavailable.

17. The digital twin federation method of claim 12, further comprising:
processing a function and data requested by a digital twin comprised in the federated digital twin;
obtaining a result of the requested function and data by interacting with GF comprised in the digital twin; and
transmitting the result of the requested function and data to a digital twin comprised in the federated digital twin.
